(19) United States
(12) Patent Application Publication
(10) Pub. No.: US 2015/0223307 A1
(43) Pub. Date: Aug. 6, 2015

(54) THEATRICAL EFFECTS CONTROLLER WITH ULTRASONIC OUTPUT

(71) Applicant: James David Smith, Raleigh, NC (US)

(72) Inventor: James David Smith, Raleigh, NC (US)

(21) Appl. No.: 14/680,021

(22) Filed: Apr. 6, 2015

Related U.S. Application Data
(63) Continuation-in-part of application No. 14/066,303, filed on Oct. 29, 2013.
Application No. 14/066,303 is a continuation-in-part of application No. 14/134,453, filed on Dec. 19, 2013.
Application No. 14/134,453 is a continuation-in-part of application No. 14/134,515, filed on Dec. 19, 2013.

(51) Int. Cl. H05B 37/02

(52) U.S. Cl. CPC H05B 37/0272

(57) ABSTRACT

Provided is a system for controlling theatrical effects. The system comprises a console and one or more wireless controller devices. The console transmits wirelessly effects parameters to the wireless controller devices. The controller devices receive the effects parameters, generate output effects parameters using a combination of zero or more of a digital effects engine, a color controller, and/or a router, and provide the output effects parameters to dimmer output channels. The dimmer output channels convert the effects parameters to pulse width modulation signals that drive light sources. The pulse width modulation signals may be of an ultrasonic frequency to limit interference with audio equipment, microphones, and musical instruments.

### CROSS-REFERENCE TO RELATED APPLICATION

This application is a continuation-in-part to U.S. application Ser. No. 14/134,453 filed on Dec. 19, 2013. This application is a continuation-in-part to U.S. application Ser. No. 14/066,303 filed on Oct. 29, 2013. This application is a continuation-in-part to U.S. application Ser. No. 14/134,515 filed on Dec. 19, 2013.

### TECHNICAL FIELD

This disclosure relates generally to devices and systems for controlling theatrical effects, and more specifically to wireless-controlled devices and systems for controlling theatrical effects, including lighting effects, in theatrical and film sets, set pieces, props, and other entertainment and educational applications.

### BACKGROUND

Devices for controlling theatrical effects are widely used in the entertainment business. Generally, a system for creating theatrical effects comprises several controller devices governing different motor engines, lamps, devices for generating lights, sound, fogs and other effects. The controller devices, in turn, are controlled by a central console using the industry-standard Digital MultipleX (DMX) protocol by means of standard DMX cables. There are also controller devices which are able to receive DMX signals via a radio network.

Propsmasters and costume designers are often called upon to incorporate various small electronic devices into their work, some of the devices are commonly available and others are custom built. For example, a show designer might demand smoke from a doll-house chimney; a costume may need to light up with LEDs executing complex chase patterns; a chair may need to collapse on demand using a hobby servo motor to pull a cable release pin. Propsmasters are often called upon to create, for example, lighting effects using light fixtures that have different color properties. Precisely matching the colors of these different lights can be difficult.

Furthermore, certain types of light fixtures brighten and dim quicker than incandescent bulbs. Incandescent filaments have natural persistence—they take time to heat up and get brighter, or cool down and get dimmer. Traditional incandescent lighting is generally perceived as more visually pleasing than other types of lighting without such natural persistence.

In addition, the frequency used by many devices for controlling theatrical effects can cause interference with audio equipment, microphones, and musical instruments. Many devices use a frequency in the audible range, e.g., 20 to 20 kHz. If one of these devices is used in close proximity to audio equipment, microphones, or musical instruments, audible interference can occur.

### SUMMARY

Embodiments of the present disclosure may address limitations present in the systems for delivering data to stage special effects devices described above.

In some embodiments, a system for generating many different features useful to propsmasters may comprise one or more portable, battery-powered, radio-controlled wireless controller devices small enough to easily hide in most theatrical and film sets, set pieces, props, and practicals. Several such wireless controller devices may be controlled by a single wireless controller.

In certain embodiments, the controller devices may incorporate a built-in color controller. By incorporating a programmable color controller into a small, battery powered wireless dimmer, it is possible for propsmasters to create completely untethered props capable of producing the desired lighting effects with far less connecting cables or channels and programming effort.

In certain embodiments, the controller devices may incorporate a dimmer output that supports ultrasonic frequencies.

In certain embodiments, the controller devices may incorporate a dimmer output that mimics the persistence of incandescent lamps.

These, and other effects, may be performed by using DMX control channels to set effect parameters, rather than directly controlling lamp dimmer intensities. In various embodiments of the present disclosure, the actual parameters may vary, particularly to specialize in a particular type of effect. In addition, these effects may be controlled, in part, by preset user-adjustable parameters.

In certain embodiments, the controller devices may also incorporate a built-in digital effects engine. In these embodiments, the controller devices may also incorporate a router that routes the effects parameters to the color controller and/or the digital effects engine according to the effects parameters and the preset user-adjustable parameters.

### BRIEF DESCRIPTION OF DRAWINGS

Embodiments are illustrated by way of example and not limitation in the figures of the accompanying drawings, in which like references indicate similar elements and in which:

FIG. 1 shows an example system for controlling theatrical effects.

FIG. 2 depicts a controller device for controlling theatrical effects according to an example embodiment.

FIG. 3 depicts a controller device for controlling theatrical effects according to another example embodiment.

FIG. 4 is a flowchart diagram showing a method for controlling lighting effects using a controller device according to an example embodiment.

FIG. 5 is a flowchart diagram showing a method for controlling lighting effects using a controller device according to an example embodiment.

FIG. 6 is a flowchart diagram showing a method for controlling lighting effects using a controller device according to an example embodiment.

### DETAILED DESCRIPTION

The following detailed description includes references to the accompanying drawings, which form a part of the detailed description. The drawings show illustrations in accordance with example embodiments.

The systems, devices and methods described herein can allow for the controlling of theatrical effects engines and devices. The controlling technology described in the present disclosure may be practiced in theatrical and film sets, set pieces, props, and other entertainment and educational applications.

In some embodiments, the system for controlling theatrical effects may comprise a main console device and a set of controller devices. In certain embodiments, the controller devices may comprise at least a receiver, a digital effects engine, a color controller, a routing controller, and several dimmer output channels. In other embodiments, the controller devices may comprise an integrated H-bridge power dimmer. The H-bridge power dimmer may be configured to operate as an AC inverter or a bidirectional DC motor driver.

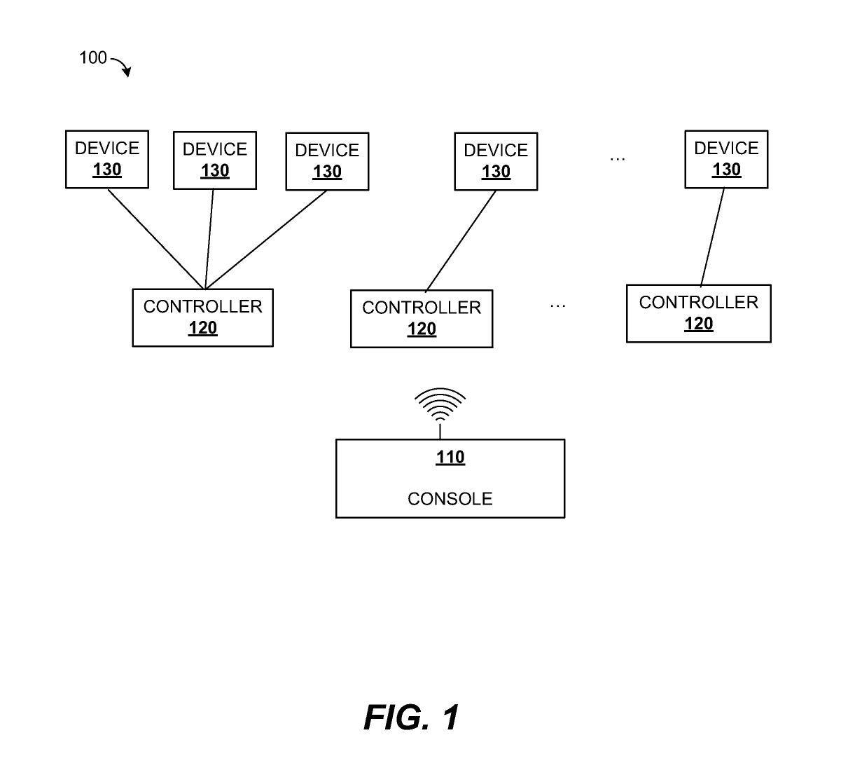

FIG. 1 shows a system 100 for controlling theatrical effects according to an example embodiment. The system 100 may comprise a console unit 110 and one or more controller devices 120. Controller devices 120 may be placed on a theatrical or film stage, or another entertainment set and controlled by console unit 110 via a radio signal. Each of the controller devices, may, in turn, govern one or more theatrical effect devices 130.

In some embodiments console unit 110 may transmit data in an industry standard format, e.g. Digital MultipleX (DMX) format, directly to controller devices 120. In other embodiments, console unit 110 may convert effect parameters presented in an industry standard format to a proprietary wireless format and transmit the effect parameters to devices 120 by a radio signal. The proprietary wireless format may use System IDs for privacy and may include error checking and other defenses against dropouts and interference. The proprietary wireless format may be, e.g., an RC4Magic format, a LumenDim format, or a Wireless Solution W-DMX format. One of ordinary skill in the art will recognize other wireless formats that the controller unit may use for transmission.

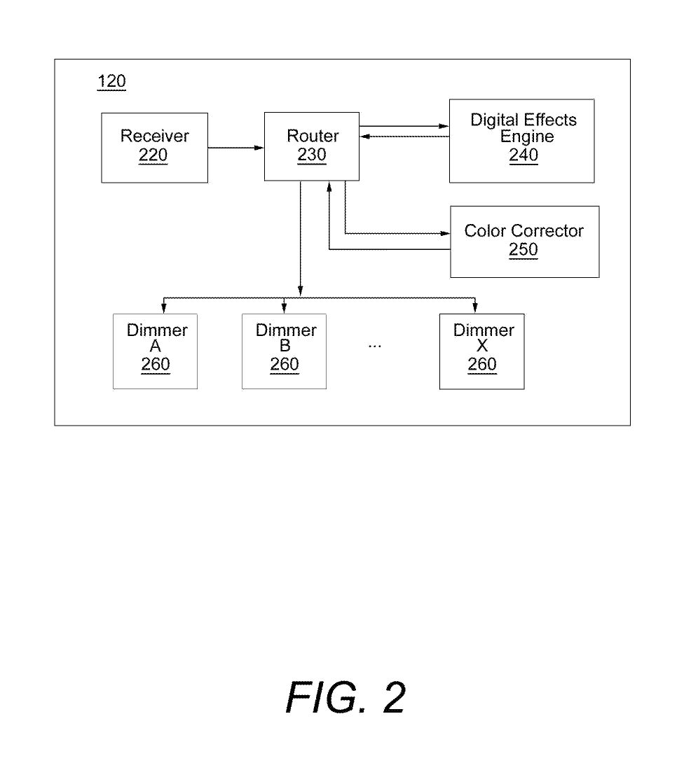

FIG. 2 depicts a device 120 for controlling theatrical effects according to an example embodiment. Device 120 may comprise at least a receiver unit 220, router 230, digital effects engine 240, color controller 250, and one or more dimmer output channels 260.

In some embodiments, controller device 120 for controlling lighting effects may be powered by a battery, while in other embodiments controller device 120 may be powered by a regular AC line.

Receiver 220 may receive effects parameters in a proprietary wireless format transmitted by the console unit 110 of FIG. 1, and convert the effects parameters to industry-standard DMX format. Each effects parameter is received on a particular DMX channel, and may correspond to a particular dimmer output. Controller device 120 may be configured to assign a DMX channel to a particular dimmer output. In one embodiment, this assignment may be accomplished by the user pressing a button corresponding to the desired dimmer output while the DMX channel to which the desired dimmer output is to be assigned is transmitting data, and while all other DMX channels are not transmitting data.

The converted effects parameters may be routed by router 230 to various modules of the system based on user-adjustable settings. The converted effects parameters may be passed to digital effects engine 240, color controller 250, or dimmer output channels 260. The output of digital effects engine 240 may be passed to color controller 250 or dimmer output channels 260. The output of color controller 250 may be passed to digital effects engine 240 or dimmer output channels 260.

Digital effects engine 240 may receive effects parameters in DMX format from receiver 220 or color controller 250. Based on the received effect parameters, the digital effects engine may generate output effects parameters in DMX format and pass the output effects parameters to color controller 250, and/or dimmer output channels 260, depending on user-adjustable settings. Digital effects engine 240 may generate output effects parameters using the received effects parameters, user-adjustable settings, one or more Low Frequency Oscillators (LFOs), and one or more Random Number Generators (RNGs) to generate a wide range of dynamic lighting effects, including simulated fire, flickering lights, etc. The LFOs may generate a triangle or saw-tooth wave form. The LFOs may be used to adjust the received effects parameters, causing a repeated brightening and dimming effect. The RNGs may be used to add randomness to the LFO waveform, so the brightening and dimming effect is variable. The RNGs may also be used directly on the received effects parameters, without a LFO waveform, to create a more variable lighting effect.

Color controller 250 may receive effects parameters in DMX format from receiver 220 or digital effects engine 240. Color controller 250 may interpret the effects parameters as Hue-Saturation-Lightness (HSL) or Hue-Saturation-Value (HSV) values. Color controller 250 may convert the received effect parameters from HSL or HSV values to Red-Green-Blue (RGB) values, depending on user-adjustable settings. Color controller 250 may also interpret the effects parameters as RGB values. The RGB values may then be color-corrected in order to match a different light source, depending on user-adjustable settings. For example, if the different light source has a stronger red component, the color controller 250 may lower the output red value to provide a closer match. The green and blue channels may also be color corrected. Color controller 250 may also adjust the RGB values in a manner to maintain steady brightness across the color spectrum. For example, if the red value needs to be reduced for color matching, the green and blue values may be increased a sufficient amount to maintain the brightness level of the output. The RGB values may then be routed to digital effects engine 240 or dimmer output channels 260.

Each of the received effects parameters may be routed along a different path by router 230. In an example embodiment, controller device 120 receives 4 effects parameters. Each of the 4 effects parameters may be routed individually to digital effects engine 240, color controller 250, or one of dimmer output channels 260

For example, in one example embodiment, each of the 4 effects parameters may be routed to a dimmer output channel. In this embodiment, the received effects parameters directly control the output of the corresponding dimmer output channel.

In another example embodiment, three of the 4 effects parameters may be routed to color controller 250 and then to the corresponding dimmer output channels, while the fourth effects parameter may be routed straight to its corresponding dimmer output channel. In this embodiment, the first three effects parameters are interpreted as HSL values and converted to RGB values by color controller 250. The fourth effects parameter directly controls the output of the corresponding dimmer output channel.

In another example embodiment, all 4 effects parameters may be routed to color controller 250 and then to the corresponding dimmer output channels 260. In this embodiment, the effects parameters are interpreted as HSL values and converted to RGBW (Red-Green-Blue-White) values by color controller 250.

In another example embodiment, three of the 4 effects parameters may be routed to digital effects engine 240 and then to the corresponding dimmer output channels 260, while the fourth effects parameter may be routed straight to its corresponding dimmer output channel 260. In this embodiment, the first three effects parameters are adjusted by digital effects engine 240 prior to driving the corresponding dimmer output channels 260. The fourth effects parameter directly controls the output of the corresponding dimmer output channel 260.

In another example embodiment, all 4 effects parameters may be routed to digital effects engine 240 and then to the corresponding dimmer output channels 260. In this embodiment, all four effects parameters are adjusted by digital effects engine 240 prior to driving the corresponding dimmer output channels 260.

In another example embodiment, three of the 4 effects parameters may be routed to digital effects engine 240, then to color controller 250, then to corresponding output channels 260. The fourth effects parameter may be routed straight to its corresponding dimmer output channel 260. In this embodiment, digital effects engine 240 adjusts the HSL input values, adding its effects to the Hue, Saturation, and Luminosity channels. After digital effects engine 240 adjusts the HSL input values, color controller 250 then converts them to RGB values, and uses these values to drive the corresponding dimmer output channels 260. The fourth effects parameters directly controls its corresponding dimmer output channel 260.

In another example embodiment, three of the 4 effects parameters may be routed to digital effects engine 240, then to color controller 250, then to corresponding output channels 260. The fourth effects parameter may be routed to digital effects engine 240, then to its corresponding dimmer output channels 260. In this embodiment, digital effects engine 240 the HSL input values, adding its effects to the Hue, Saturation, and Luminosity channels. After digital effects engine 240 adjusts the HSL input values, the color controller 250 then converts them to RGB values, and uses these values to drive the corresponding dimmer output channels 260.

In another example embodiment, all of the effects parameters may be routed to digital effects engine 240, then to color controller 250, then to corresponding output channels 260. In this embodiment, digital effects engine 240 adjusts the HSL input values, adding its effects to the Hue, Saturation, and Luminosity channels. After digital effects engine 240 adjusts the HSL input values, the color controller 250 then converts them to RGBW values, and uses these values to drive the corresponding dimmer output channels 260.

Many other routing configurations are possible, and will be apparent to one of ordinary skill in the art. Any number of effects parameters may be received, limited only by the number of DMX parameters capable of being transmitted. Each of these effects parameters may be routed to any combination of the disclosed modules, in any order, and then routed to one of dimmer output channels 260.

Dimmer output channels may receive effects parameters from receiver 220 digital effects engine 240, or color controller 250. Each of dimmer output channels 260 may be connected to a light source. Dimmer output channels 260 may power the connected light source using Pulse-Width-Modulation (PWM). Dimmer output channels 260 may control the intensity of the connected light source by adjusting the average voltage and/or the frequency based on the received effects parameters, according to PWM dimming techniques known to those of ordinary skill in the art.

The PWM frequency may be user-adjustable. For example, the user may select a PWM frequency from a range of possible PWM frequencies. The range of user-selectable frequencies may include frequencies for high power handling, frequencies for flicker-free dimming, frequencies for artifact-free video capture, and ultrasonic frequencies that eliminate audio interference. The ultrasonic frequency may be 20 kHz or higher. One of ordinary skill in the art will recognize other PWM frequencies that provide beneficial effects, and these frequencies are also within the scope of the present invention.

Dimmer output channels 260 may alter the received effects parameters according a user-selected curve. Types of user-selected curves may include linear, non-dim, inverse-square-law (ISL), inverted linear, inverted non-dim, and inverted ISL. If the selected curve is linear, the received effects parameters are not modified. If the selected curve is ISL, the received effects parameters are modified according to the inverse square law. If the selected curve is non-dim, the output is 100% if the received effects parameters are greater than a specified threshold input level, and the output is 0% if the received effects parameters are less than a specified threshold input level. The non-dim curve may include hysteresis to avoid unwanted oscillations near the threshold input level. For example, the output may switch to 100% only if the threshold is exceeded by a certain amount, and, conversely, the output may switch to 0% only if the input level is under the threshold by a certain amount. The inverted versions of these curves are the inverse of the above, and will be apparent to one of ordinary skill in the art.

Dimmer output channels 260 may also adjust the output to provide a smooth transition effect when received effects parameters are changing. The effects parameters received by dimmer output channels may be 8-bit, capable of 256 different values. In addition, dimmer output channels may be capable of outputting 16-bit values, which are capable of 65,536 values. However, without additional smoothing, this may cause a multiple-step jump in output due to a single-step change in the received effects parameters. For example, a change of the received effects parameters from 1 to 2 would result in a change of output from 256 to 512. Dimmer output channels 260 may, instead of jumping directly from 256 to 512, send output signals to the light sources that move incrementally from 256 to 512. The output curve may be linear or non-linear, and may be of variable speed. Furthermore, the output curve of a rising received effects parameter may be different from the output curve of a declining received effects parameter. User-adjustable settings may control the type of output curve, e.g. linear or non-linear, and the speed of the curve. The user-adjustable settings may also correspond to various sizes and wattages of incandescent bulbs.

Controller device 120 may also include other features, the implementation of which will be known to one of ordinary skill in the art. Controller device 120 may include a power-up blink controller, which controls the blink time for dimmer outputs 260 when controller device 120 is powered on. The blink time is user-configurable; it may be set to 0 for no power-up blink, and alternatively may be set to a value to control the blink time for dimmer outputs 260.

Controller device 120 may include a dimmer timeout period controller. In the absence of additional data received by receiver 220, the dimmer timeout period is the length of time the dimmer will hold the last received value. The dimmer timeout period may be user-adjustable.

Controller device 120 may also include one or more sensors that can sense, e.g., power supply voltage, internal temperature, current draw, and/or rf power.

Controller device 120 may also include a remote device management (RDM) controller. Controller device 120 may include a root device and multiple subdevices, including subdevices corresponding to digital effects engine 240, color controller 250, and/or dimmer output channels 260. The RDM controller may respond to external requests for information about various parameters defined in connection with the subdevices. Each parameter is associated with a parameter ID (PID), and the external request must identify the PID it wants to access.

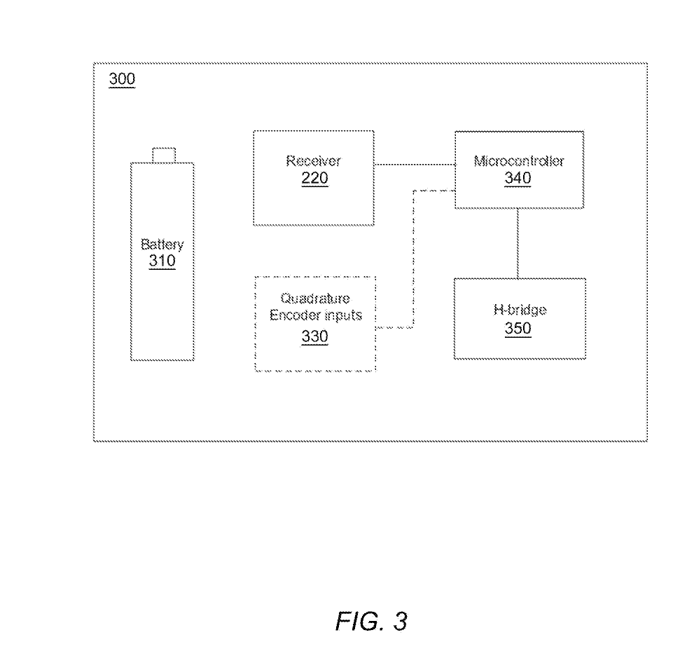

FIG. 3 shows another example embodiment of a controller device 300 with an integrated H-bridge power dimmer for controlling theatrical effects. The device 300 may include at least a battery 310, receiver 220, a microcontroller 340, and one or more integrated H-bridge power dimmers. Device 300 may also optionally include router 230 (not shown), digital effects engine 240 (not shown) and color controller 250 (not shown). In some embodiments, the device 300 of FIG. 3 may further include quadrature encoder inputs 330. Device 300 operates substantially identically to controller device 120, with the addition of microcontroller 340 and the integrated H-bridge power dimmers. Receiver 220 is identical to the receiver described above in connection with FIG. 2. The microcontroller 340 may include a firmware and a storage memory. The microcontroller 340 may be configured to receive DMX data from receiver 220 and control the H-bridge power dimmer 350.

The DMX data may provide, to microcontroller 340, a selection of a functional mode of H-bridge power dimmer 350 and parameters of operations associated with selected mode. The functional modes include, but are not limited to, bidirectional control of DC motors, DC motor speed control, DC motor servo positioning, telephone bell ringing, dimming of electroluminescent (EL) materials, and speed control of AC motors. In some embodiments, several DMX channels may be reserved for parameters controlled in real time by user via console 110. To ensure appropriate range and influence, incoming DMX data can be scaled, inverted, and shifted before being applied to any particular parameter. The same DMX channel can simultaneously influence multiple parameters, each with independent scaling.

In some embodiments, the H-bridge power dimmer 350 may be configured to operate as an inverter to produce AC waves. The microcontroller 340 may be configured to control the frequency, amplitude, and shape of the AC wave. In some example embodiments, the microcontroller 340 may set the H-bridge power dimmer 350 to generate an AC wave with high frequency (e.g. 300 Hz) and amplitude of the AC waves being controlled using an assigned DMX channel by a user via wireless console 110. The resulting AC wave may be used for generating a dimming electroluminescent (EL) wire.

In other example embodiments, the microcontroller 340 may set the H-bridge power dimmer 350 to generate sine AC waves with a frequency being controlled using an assigned DMX channel by a user via console 110. The output can be used to control the speed of a synchronous AC motor in, for example, an electric clock or fan.

In yet another example of embodiments, the microprocessor 340 may set the H-bridge power dimmer to generate a 20 Hz sine wave. One DMX channel may be assigned to control the amplitude of this wave by a user via console 110, with a non-dim (switching) response. The output may be used for ringing a telephone bell. The ring pattern may be also controlled directly from console 110.

In other set of embodiments the H-bridge power dimmer 350 may be configured to operate as bidirectional DC motor driver. For an example, the H-bridge in bidirectional DC motor driver mode may be used to control a linear actuator that opens and closes a door. In some embodiments, the quadrature encoder inputs 330 may be used to allow the H-bridge power dimmer 350 to be configured as a closed-loop servo controller.

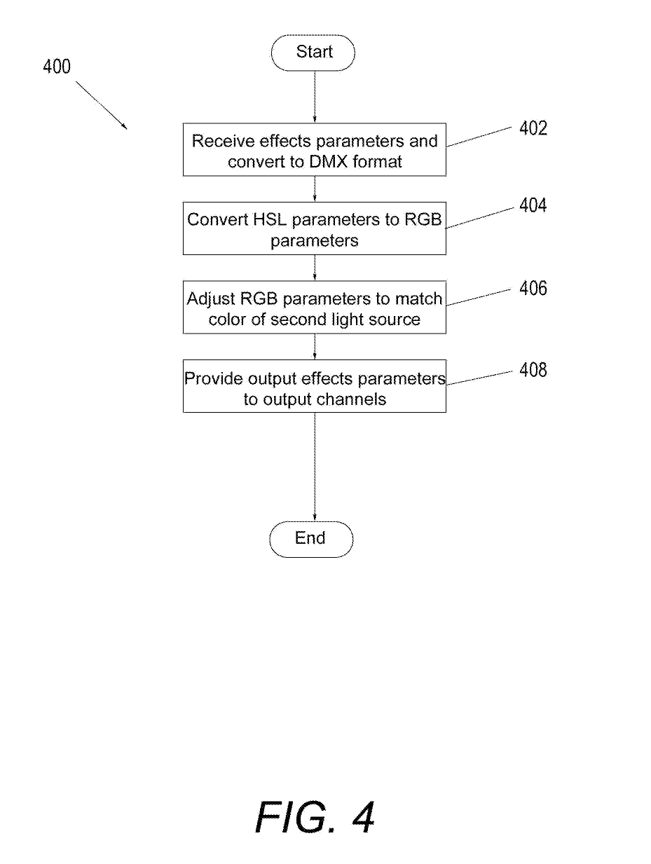

FIG. 4 is a flow chart diagram illustrating a method 400 for controlling lighting effects using controller devices 120 according to an example embodiment. The method 400 of FIG. 4 may also include additional or fewer steps than those illustrated.

In step 402, HSL effects parameters may be received by receiver 220 from console unit 110 via a radio signal. The effect parameters may be further converted from a proprietary format to an industry-standard DMX format and passed to color controller 250.

In step 404, color controller 250 may convert the HSL effects parameters to RGB effects parameters.

In step 406, color controller 250 may adjust the RGB effects parameters to match the color of a first light source with a second light source.

In step 408, output effects parameters generated by color controller 250 may be provided to dimmer output channels 260 to control external light sources.

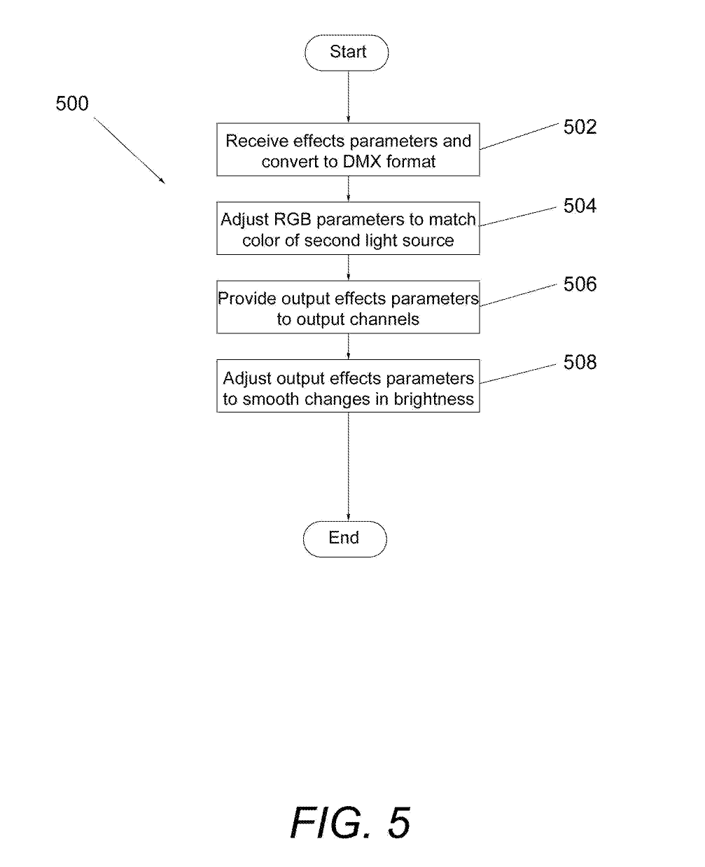

FIG. 5 is a flow chart diagram illustrating a method 500 for controlling lighting effects using controller devices 120 according to another example embodiment. The method 500 of FIG. 5 may also include additional or fewer steps than those illustrated.

In step 502, RGB effects parameters may be received by receiver 220 from console unit 110 via a radio signal. The effects parameters may be further converted from a proprietary format to an industry-standard DMX format and passed to color controller 250.

In step 504, color controller 250 may optionally adjust the RGB effects parameters to match the color of a first light source with a second light source.

In step 506, output effects parameters generated by color controller 250 may be provided to dimmer output channels 260 to control external light sources.

In step 508, dimmer output channels may adjust the output effects parameters to smooth changes in brightness.

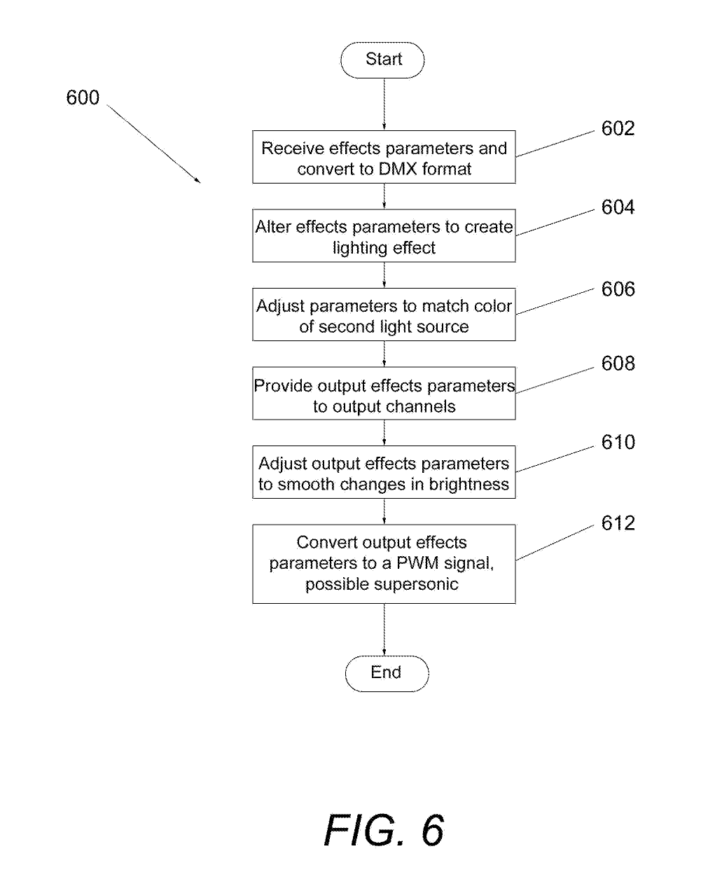

FIG. 6 is a flow chart diagram illustrating a method 600 for controlling lighting effects using controller devices 120 according to another example embodiment. The method 600 of FIG. 6 may also include additional or fewer steps than those illustrated.

In step 602, effects parameters may be received by receiver 220 from console unit 110 via a radio signal. The effect parameters may be further converted from a proprietary format to an industry-standard DMX format and optionally passed to digital effects engine 240.

In step 604, digital effects engine 240 may alter the effects parameters to generate a lighting effect.

In step 606, color controller 250 may adjust the effects parameters to match the color of a first light source with a second light source.

In step 608, output effects parameters generated by color controller 250 may be provided to dimmer output channels 260 to control external light sources.

In step 610, dimmer output channels may adjust the output effects parameters to smooth changes in brightness.

In step 612, dimmer output channels may convert the output effects parameters to a pulse-width-modulation signal, optionally an ultrasonic pulse-width-modulation signal.

Although the invention has been described in terms of particular embodiments, one of ordinary skill in the art, in light of the teachings herein, can generate additional embodiments and modifications without departing from from the spirit of, or exceeding the scope of, the claimed invention. This invention is not limited to using the particular processors, modules, parameters, variables, and data elements described herein, and other processors, modules, parameters, variables, and data elements will be equivalent for the purposes of this invention. Accordingly, it is understood that the drawings and the descriptions herein are proffered only to facilitate comprehension of the invention and should not be construed to limit the scope thereof.

1. A wireless dimmer device for controlling lighting effects, the dimmer device comprising:
a receiver;
one or more Pulse Width Modulation outputs configured to provide an output of an ultrasonic frequency to avoid audio interference;

2. The device of claim 1, further comprising a battery to power the device.

3. The device of claim 1, wherein the device is powered by an alternating current line voltage.

4. The device of claim 1, wherein the ultrasonic frequency is 20 kHz or higher.

5. The device of claim 1, wherein the receiver is configured to:
receive effects parameters in a proprietary format; and
convert received effects parameters to Digital MultipleX (DMX) format.

6. The device of claim 5, wherein the receiver is further configured to provide the converted effects parameters to the Pulse Width Modulation output.

7. The device of claim 5, further comprising a processor for altering the converted effects parameters according to user-adjustable settings, wherein the receiver is further configured to provide the converted effects parameters to the processor.

8. A system for controlling lighting effects, the system comprising:
a controller;
one or more dimmer devices for controlling effects, the dimmer devices comprising:
a receiver;
one or more Pulse Width Modulation outputs configured to provide an output of an ultrasonic frequency to avoid audio interference;

9. The system of claim 8, wherein the controller is configured to:
convert effects parameters from Digital Multiplex format to a proprietary format; and
transmit wirelessly the effects parameters in the proprietary format.

10. The system of claim 8, further comprising a battery to power the device.

11. The system of claim 8, wherein the device is powered by an alternating current line voltage.

12. The system of claim 8, where the ultrasonic frequency is 20 kHz or higher.

13. The system of claim 8, wherein the receiver is configured to:
receive effects parameters in a proprietary format; and
convert received effects parameters to Digital MultipleX (DMX) format.

14. The system of claim 13, wherein the receiver is further configured to provide the effects parameters to the Pulse Width Modulation output.

15. The system of claim 13, further comprising a processor for altering the converted effects parameters according to user-adjustable settings, wherein the receiver is further configured to provide the converted effects parameters to the processor.

16. A method for controlling lighting effects, the method comprising
receiving effects parameters in a proprietary format;
converting the effects parameters to industry-standard DMX format;
providing the effects parameters to dimmer output channels; and
providing an ultrasonic Pulse Width Modulation output signal based on the effects parameters to a light source.

17. The method of claim 16 where the output signal has a frequency of 20 kHz or higher.

18. The method of claim 16 further comprising the steps of:
providing the effects parameters to a processor; and
altering the effects parameters according to user-adjustable settings.
